(19) United States
(12) Patent Application Publication
(10) Pub. No.: US 2007/0017254 A1
(43) Pub. Date: Jan. 25, 2007

(54) Composite mold and method for making the same

(75) Inventor: Shih-Chieh Yen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/440,379

(22) Filed: May 24, 2006

(30) Foreign Application Priority Data
Jul. 19, 2005 (CN) 200510036112.3

(51) Int. Cl. C03B 9/48; B05D 1/36; B05D 7/00

(52) U.S. Cl. 65/374.12; 427/404

(57) ABSTRACT

A composite mold includes a mold base having a molding surface, a first adhering layer formed on the molding surface, a first diffusion barrier layer formed on the first adhering layer, and a first protective layer formed on the first diffusion barrier layer. The material of the first protective layer is silicon-doped diamond-like carbon. A method for making the composite mold is also provided.

### TECHNICAL FIELD

The present invention relates to a mold for molding glass articles, and more particularly relates to a mold having a protective film and a method for making the same.

### BACKGROUND

Glass optical articles, such as aspheric lenses, ball-shaped lenses, prisms, etc. are generally made by a direct press-molding process using a mold. The glass optical articles obtained by the direct press-molding method have the advantage of not needing to undergo further processing, such as polishing etc. Accordingly, the manufacturing efficiency can be greatly increased. However, the mold used in the direct press-molding method has to satisfy certain critical requirements such as high chemical stability, resistance to heat shock, good mechanical strength, and good surface smoothness.

Several criteria that should be considered in choosing the material for making the mold are listed below:
a. the mold formed from such material is rigid and hard enough so that the mold cannot be damaged by scratching and can withstand high temperatures;
b. the mold formed from such material is highly resistant to deformation or cracking even after repeated heat shock;
c. the mold formed from such material does not react with or adhere to the glass material at high temperatures;
d. the material is highly resistant to oxidization at high temperatures;
e. the mold formed of such material has good machinability, high precision, and a smooth molding surface; and
f. the manufacturing process using the mold is cost-effective.

In earlier years, the mold was usually made of stainless steel or a heat resistant metallic alloy. However, such a mold suffers from the disadvantage that crystal grain size of the mold material gradually become larger and larger over a period of time of usage, whereby the surface of the mold becomes more and more rough. In addition, the mold material is prone to being oxidized at high temperatures. Furthermore, the glass material tends to adhere to the molding surface of the mold.

Therefore, non-metallic materials and super hard metallic alloys have been developed for making molds. Such materials and alloys include silicon carbide (SiC), silicon nitride (Si₃N₄), titanium carbide (TiC), tungsten carbide (WC), and a tungsten carbide-cobalt (WC—Co) metallic alloy. However, SiC, Si₃N₄ and TiC are ultrahard ceramic materials. It is difficult to form such materials into a desired shape, especially an aspheric shape, with high precision. Furthermore, WC and a WC—Co alloy are liable to be oxidized at high temperatures. All in all, these materials are not suitable for making high-precision molds.

Thus, a composite mold comprising a mold base and a protective film formed thereon has been developed. The mold base is generally made of a carbide material or a hard metallic alloy. The protective film is usually formed on a molding surface of the mold base.

Typically, the mold base of the composite mold is made of a hard metallic alloy, a carbide ceramic, or a metallic ceramic. The protective film of the composite mold is formed of a material selected from the group consisting of iridium (Ir), ruthenium (Ru), an alloy of Ir, platinum (Pt), rhenium (Re), osmium (Os), rhodium (Rh), and an alloy of Ru, Pt, Re, Os and Rh.

Another composite mold used for molding optical glass products includes a mold base made of a hard metallic alloy, a carbide ceramic, or a metallic ceramic, and a protective film formed thereon, with a diamond-like carbon material.

However, the protective film made of inert metals or alloys has a high cost, while that made of diamond-like carbon has low heat stability as crystal structures are prone to change when heated to high temperatures.

Therefore, a composite mold with low cost and long lifetime and a method for making such a mold are desired.

### SUMMARY

A composite mold includes a mold base having a molding surface, a first adhering layer formed on the molding surface, a first diffusion barrier layer formed on the first adhering layer, wherein the first adhering layer is configured for enhancing adhesive ability of the first diffusion barrier layer to the molding surface, and a first protective layer formed on the first diffusion barrier layer, wherein the first diffusion barrier layer is configured for preventing reaction between the first adhering layer and the first protective layer, the first protective layer being comprised of silicon-doped diamond-like carbon.

A method for making a composite mold includes the steps of: providing a mold base with a molding surface, forming a first adhering layer on the molding surface of the mold base, forming a first diffusion barrier layer on the first adhering layer, and forming a first protective layer on the first diffusion barrier layer, the first protective layer being comprised of silicon-doped diamond-like carbon.

Other advantages and novel features will become more apparent from the following detailed description when taken in conjunction with the accompanying drawings.

### BRIEF DESCRIPTION OF THE DRAWINGS

Many aspects of a composite mold and a method for making the same can be better understood with reference to the following drawings. The components in the drawings are not necessarily drawn to scale, the emphasis instead being placed upon clearly illustrating the principles of the composite mold and the method for making the same. Moreover, in the drawings, like reference numerals designate corresponding parts throughout the several views.

FIG. 1 is a schematic, cross-sectional view showing a composite mold in accordance with a first embodiment of the present invention; and

FIG. 2 is a schematic, cross-sectional view showing a composite mold in accordance with a second embodiment of the present invention.

### DETAILED DESCRIPTION OF THE EMBODIMENTS

The present invention is further described below and by reference to the figures.

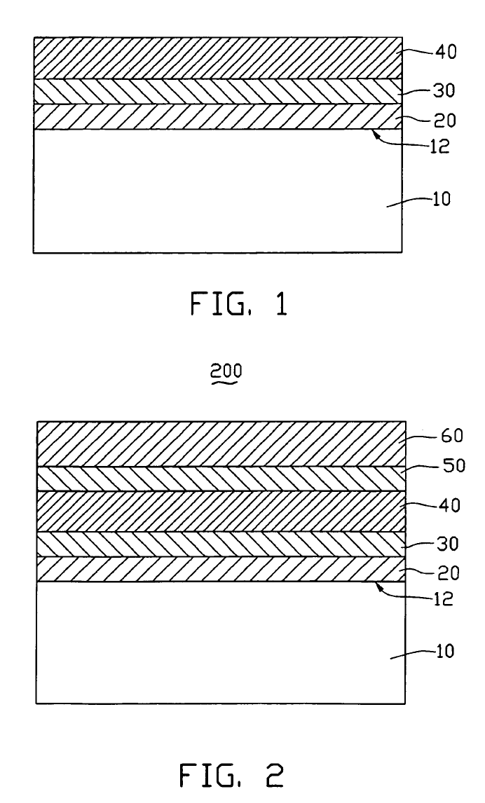

Referring to FIG. 1, a composite mold 100 of a first preferred embodiment used for molding optical glass products comprises a mold base 10 having a molding surface 12, a first adhering layer 20 formed on the molding surface 12, a first diffusion barrier layer 30 formed on the first adhering layer 20, and a first protective layer 40 formed on the first diffusion barrier layer 30. A material of the first protective layer 40 is silicon-doped diamond-like carbon.

The mold base 10 is made of ceramic, metallic ceramic or ultrahard alloy materials, such as SiC, Si, Si₃N₄, ZrO₂, Al₂O₃, TiN, TiO₂, TiC, B₄C, WC, W or WC—Co. The first adhering layer 20 is comprised of titanium (Ti) or chromium (Cr). The first diffusion barrier layer 30 is comprised of TiN.

It is preferable that a surface roughness of peak to valley of the molding surface 12 is less than 0.05 micrometer. Thus the first adhering layer 20 can compactly adhere to the molding surface 12, which makes the mold 100 highly durable. Since the first protective layer 40 is made of silicon-doped diamond-like carbon having a high rigidity and low frictional coefficient, it can act as a good material for use in mold.

Generally, a surface roughness of the first protective layer 40 is in the range from 0.2 to 1.2 micrometers as when the surface roughness is lower than 0.2 micrometers, the products manufactured can be difficult to release from the mold and when the surface roughness is higher than 1.2 micrometers the resulting product will be overly rough.

A thickness of the first adhering layer 20 or the first diffusion barrier layer 30 is in the range from 0.05 to 0.1 micrometers. A thickness of the first protective layer 40 is in the range from 0.5 to 3 micrometers. The first adhering layer 20 functions to improve adhesion between the first diffusion barrier layer 30, the first protective layer 40 and the mold base 10. The first diffusion barrier layer 30 is functioned to prevent active atoms of the first adhering layer 20 diffusing into the first protective layer 40 and re-acting with the material of the first protective layer 40, thus affecting the property of the first protective layer 40.

Referring to FIG. 2, another composite mold 200 used for manufacturing optical glass products of a second preferred embodiment is provided. Different from that of the first preferred embodiment, the composite mold 200 further comprises a second adhering layer 50 formed on the first protective layer 40, and a second protective layer 60 formed on the second adhering layer 50. It is preferable that a second diffusion barrier layer (not shown) should be formed between the second adhering layer 50 and the second protective layer 60. In the second preferred embodiment, even if the second protective layer 60 is damaged, it can still be used if the second protective layer 60, the second adhering layer 50, and the second diffusion barrier layer (if any) are removed.

Referring to FIG. 1, a method for manufacturing the composite mold comprises the following steps: providing a mold base 10 having a molding surface 12; forming a first adhering layer 20 on the molding surface 12; forming a first diffusion barrier layer 30 on the first adhering layer 20; and forming a first protective layer 40 on the first diffusion barrier layer 30, with a material of silicon-doped diamond-like carbon, thereby forming a composite mold 100.

First of all, a mold base 10 with a molding surface 12 is provided. The molding surface 12 is ground to produce a surface with a roughness of less than 0.05 micrometers, and then the mold base 10 can be cleaned with a supersonic oscillation or sputtering cleaning method. The mold base 10 can be made of ceramic, metallic ceramic, or ultrahard alloy materials, such as SiC, Si, Si₃N₄, ZrO₂, Al₂O₃, TiN, TiO₂, TiC, B₄C, WC, W or WC—Co. Preferably, the molding surface 12 can be ground to produce a surface with a roughness of about 0.03 micrometers, the mold base 10 can then be placed in acetone solution to be cleaned by a supersonic oscillation cleaning method for 10 minutes, the mold base 10 can then be dried with a nitrogen gun. The mold base 10 can then be placed into a magnetron sputtering apparatus to be cleaned by plasma under a bias voltage of about 300V and in an argon atmosphere with a pressure of about 2˜7×10⁻³ torr.

Secondly, a first adhering layer 20 is formed on the molding surface 12 of the mold base 10. The first adhering layer 20 can be formed by sputtering or chemical vapor deposition method. The sputtering method can be bias voltage reactive sputtering, radio frequency sputtering or co-sputtering. A material of the first adhering layer 20 can be Ti or Cr. A thickness thereof can be in the range from 0.05 to 0.1 micrometer. Preferably, the first adhering layer 20 can be formed by bias voltage reactive sputtering method, with a bias voltage in the range from about −20 to −60V, a target being Ti metal, and in an argon atmosphere with a pressure of about 2˜7×10⁻³ torr, thus forming a adhering layer 20 with a thickness of 0.6 micrometers.

Thirdly, a first diffusion barrier layer 30 is formed on the first adhering layer 20. The operation is similar to that of the second step. The difference is that the first diffusion barrier layer 30 can be formed under a mixed gas of argon and nitrogen in an atmosphere with a pressure of about 2˜7×10⁻³ torr, thus the first diffusion barrier layer 30 material of the is TiN.

Fourthly, a first protective layer 40 is formed on the first diffusion barrier layer 30, which with a material of silicon-blended diamond-like carbon, can form a mold 100. The first protective layer 40 is formed by sputtering or chemical vapor deposition method. The sputtering method can be bias voltage reactive sputtering, radio frequency sputtering or co-sputtering method. A material of the first protective layer 40 can be silicon blended and diamond-like carbon. A thickness thereof is in the range from 0.5 to 3 micrometers. Preferably, the first protective layer 40 is formed by a co-sputtering method with a bias voltage in the range from −50 to −100V, targets being graphite and silicon, and an argon atmosphere of about 2˜10×10⁻³ torr, thus forming a first protective layer 40 with a thickness of 2 micrometers. In this way the mold 100 is completed.

The mold 100 may also be annealed under a annealing temperature in the range from 200 to 300 degrees centigrade. Preferably, the mold 100 is placed into a heat cavity, and then annealed for 0.5 to 2 hours at a temperature of about 250 degrees centigrade, with argon used as a protective gas. Thus the surface roughness of the first protective layer 40 can be kept in the range from about 0.2 to 1.2 micrometers.

Referring to FIG. 2, a second method for manufacturing the second mold 200 is also provided. As well as those steps used in the first method, the second method further comprises the following steps after the fourth step of the first method: forming a second adhering layer 50 on the first protective layer 40, and then forming a second protective layer 60 on the second adhering layer 50. It can also comprise a step of forming a second diffusion barrier after forming the second adhering layer 50, prior to forming the second protective layer 60. The second adhering layer 50, the second protective layer 60 can be formed in the same way as the second step and the fourth step. The second diffusion barrier (if needed) can be formed in the same way as the third step of the first method.

Similarly, the mold 200 can also be annealed in the same way as that in the first method.

Compared with conventional molds, the composite mold 100, 200 of the present application has the following advantages. The material of the first protective layer 40 is silicon-doped diamond-like carbon, in the presence of silicon, the crystal structure of the diamond-like carbon material can be stable at a high temperature. Thus the first protective layer 40 can be prevented from being unstable at high temperatures and further affect the durability of the mold. Surface roughness of the molding surface 12 of the mold base 20 is less than 0.05 micrometers, thus the first adhering layer 20 can compactly adhere to the molding surface 12, thus making the mold more durable.

Furthermore, when the second protective layer 60 is presented, even if it is damaged, the mold 200 can still be used if the second adhering layer 50 and the second protective layer 60 are removed by grinding, thus cost can be decreased and lifetime can be prolonged. In addition, when it is annealed, surface roughness of the first protective layer of the mold can be kept in the range from 0.2 to 1.2 micrometers, thus products can easily be released from the mold.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A composite mold comprising:
a mold base having a molding surface;
a first adhering layer formed on the molding surface;
a first diffusion barrier layer formed on the first adhering layer, wherein the first adhering layer is configured for enhancing adhesion of the first diffusion barrier layer to the molding surface; and
a first protective layer formed on the first diffusion barrier layer, wherein the first diffusion barrier is configured for preventing reaction between the first adhering layer and the first protective layer, the first protective layer is comprised of silicon-doped diamond-like carbon.

2. The composite mold in accordance with claim 1, further comprising a second adhering layer formed on the first protective layer, and a second protective layer formed on the second adhering layer.

3. The composite mold in accordance with claim 2, further comprising a second diffusion barrier formed between the second adhering layer and the second protective layer.

4. The composite mold in accordance with claim 1, wherein a surface roughness of the molding surface is less than 0.5 micrometers.

5. The composite mold in accordance with claim 1, wherein the first adhering layer is comprised of titanium or chromium, a thickness thereof being in the range from 0.05 to 0.1 micrometers.

6. The composite mold in accordance with claim 1, wherein the first diffusion barrier is comprised of TiN, a thickness thereof being in the range from 0.05 to 0.1 micrometers.

7. The composite mold in accordance with claim 1, wherein a thickness of the first protective layer is in the range from 0.5 to 3 micrometers.

8. The composite mold in accordance with claim 1, wherein a surface roughness of peak to valley of the first protective layer is in the range from 0.2 to 1.2 micrometers.

9. A method for making a composite mold, comprising the steps of:
providing a mold base with a molding surface;
forming a first adhering layer on the molding surface of the mold base;
forming a first diffusion barrier layer on the first adhering layer; and
forming a first protective layer on the first diffusion barrier, the first protective layer being comprised of silicon-doped diamond-like carbon.

10. The method for making a composite mold in accordance with claim 9, further comprising the following steps:
forming a second adhering layer on the first protective layer; and
forming a second protective layer on the second adhering layer.

11. The method for making a composite mold in accordance with claim 10, further comprising a step of forming a second diffusion barrier layer on the second adhering layer prior to forming the second protective layer.

12. The method for making a composite mold in accordance with claim 9, wherein prior to forming the first adhering layer, the molding surface of the mold base is ground and cleaned.

13. The method for making a composite mold in accordance with claim 12, wherein the molding surface is cleaned by at least one of the following methods: supersonic oscillation cleaning or sputtering cleaning process.

14. The method for making a composite mold in accordance with claim 9, wherein the first adhering layer, the first diffusion barrier layer and the first protective layer are formed by one of a sputtering process and a chemical vapor deposition process.

15. The method for making a composite mold in accordance with claim 9, further comprising a step of annealing the treated mold base after the first protective layer is formed.

16. The method for making a composite mold in accordance with claim 10, further comprising a step of annealing the treated mold base after the second protective layer is formed.
